(19) United States
(12) Patent Application Publication
(10) Pub. No.: US 2015/0274325 A1
(43) Pub. Date: Oct. 1, 2015

(54) METHOD OF AND SYSTEM FOR HANDLING EARLY BAGGAGE IN AN AIRPORT

(71) Applicant: CRISPLANT A/S, Aarhus N (DK)

(72) Inventor: Uffe Lykkegaard, Aarhus C (DK)

(21) Appl. No.: 14/437,438

(22) PCT Filed: Oct. 31, 2013
(86) PCT No.: PCT/DK2013/050350

§ 371 Date: Apr. 21, 2015

(30) Foreign Application Priority Data
Oct. 31, 2012 (DK) PA 2012 70667
Dec. 21, 2012 (DK) PA 2012 70809

(51) Int. Cl. B64F 1/36; B65G 37/00; B65G 47/26

(52) U.S. Cl. CPC B64F 1/368; B65G 47/261; B65G 37/00

(57) ABSTRACT

In order, e.g., to prevent high fluctuations in capacity requirements at various positions in a baggage handling system in an airport there is disclosed an automated airport baggage handling system 222 comprising an induction for loading a piece of baggage onto a baggage tote 402 of the airport baggage handling system, and a discharge 306 for unloading baggage from the baggage tote. The system further includes one or more baggage storage units 308, each being provided as a lift configured for storing a plurality of loaded baggage totes above each other, and where the plurality of totes are stored in-line with a conveyor line 404 used for transporting the baggage totes to and from the one or more baggage storage units 308.

### FIELD OF THE INVENTION

The invention relates to handling of airport baggage in an airport, and in particular to a method of handling airport baggage in totes in an automated airport baggage handling system.

### BACKGROUND OF THE INVENTION

Automated airport baggage handling systems are used for handling and distribution of airport baggage. Such handling may e.g. take place between a check-in station in an airport terminal and one or more areas, which one or more areas are possibly close to where aircrafts take off and land.

Baggage can be checked in at an airport baggage check-in station in the terminal and handled, such as transported, by the automated airport baggage handling system from the terminal to a position where baggage for a destination in the handling system can be collected and stored. Baggage can also be in transit, i.e. the baggage is to be transferred from one aircraft arriving at the airport at a given time and towards another aircraft, taking off from the airport some period hereafter.

Often, airports have more than one terminal, e.g. an old and a new or a domestic and an international or comprise 5-10, or more, terminals. Such airports, with such terminals, where each terminal normally has a plurality of gates, are often spread across several square kilometres.

Handling, distribution and transport of airport baggage between a terminal and a gate at that terminal, or between terminals, or handling baggage in transit, often needs to be carried out over distances of several hundred meters, or even 5-10 kilometres, within a short period of time, such as e.g. 10-30-45 minutes.

Thus, transport of baggage is often provided at elevated speeds, such as 1-10 m/s or 2-10 m/s, in order to distribute the baggage within the short period of time. In order to assure a hassle free distribution of various types of baggage at such speeds, the baggage is often positioned in dedicated transport units, often referred to as totes.

Typically, new, as well as existing, systems experience disadvantages related to their capacity, cost and/or a transit time and/or a transport period for one or more particular pieces of baggage. In particular, for new and existing solutions, improving one of these factors often has a high and non-beneficial impact on one or more of the other factors.

Particular disadvantages may arise when handling so-called early baggage.

Thus, it has been appreciated that an improved method of and system for handling airport baggage, in airport baggage totes, in an automated baggage distribution system in an airport, is of benefit, and in consequence the present invention has been devised.

### SUMMARY OF THE INVENTION

It may be seen as an object of the present invention to provide an improved method of and system for handling airport baggage, in airport baggage totes, in an automated baggage distribution system in an airport.

Preferably, the invention alleviates, mitigates or eliminates one or more of the above or other disadvantages singly or in any combination. In particular, it may be seen as an object of the invention to provide a method and a system which decreases an average transport time for baggage and/or prevents single pieces of baggage of having a transport or transit time, between various locations in the system, which is far longer than an average transport time, at a significantly decreased cost, when compared to reference method and systems.

Accordingly, there is provided a method of handling baggage in an airport, in an automated airport baggage handling system, the method comprising

a) entering a piece of baggage in the system, such as checking in the piece of baggage at a check-in station, or entering a piece of transit baggage in the system,

b) loading the piece of baggage onto a baggage tote, to form a loaded baggage tote,

c) moving the loaded baggage tote towards an end destination of the piece of baggage in the automated airport baggage handling system,

d) storing a plurality of loaded baggage totes in a baggage storage unit, near or at the end destination, by

e) separating the loaded baggage tote from a conveyor line used for transporting the baggage totes to and from the baggage storage unit,

f) inserting the loaded baggage tote into the baggage storage unit by
f1) lifting the loaded baggage tote from the conveyor line and into the baggage storage unit, and

g) supporting the loaded baggage tote in the baggage storage unit, and when the baggage is needed:

h) withdrawing the loaded baggage tote from the baggage storage unit by lowering the loaded baggage tote from the baggage storage unit to the conveyor line,

i) emptying the tote at a discharge,

j) moving the baggage from the automated airport baggage handling system and into an aircraft.

Thus, an improved method of handling airport baggage, in airport baggage totes, in an automated baggage distribution system in an airport, is provided. It may be seen that the improvement lies in the way the baggage is handled as described in one or more of the method steps a)-j).

Conveyor systems for handling baggage in an airport and for conveying and sorting baggage for a number of different destinations typically have a number of discharges for discharging baggage at specific end destinations in the automated airport baggage handling system. These end destinations are positioned in areas of the airport which may be referred to as leaving areas in that here the baggage leaves the baggage handling system.

In the leaving areas some manual supervision and/or operation takes place. This needs to be coordinated with other manual operations and/or automated operations. The coordination between tasks to be performed is, among others performed in response to when, where and which amount of baggage is positioned in the baggage handling system.

Some baggage pieces that the system handles are entered into the system some hours before the term for needing these baggage pieces at the leaving area for make-up operation for a desired flight departure. Some baggage pieces arrive to the baggage handling system even earlier, and such baggage is often referred to as “early bags or early baggage”, which is baggage that is checked-in very early or baggage in transit. Most baggage handling systems in airports include a central baggage storage unit, also for early baggage, such as one or more long conveyors on which the baggage may be temporarily stored until a discharge is opened for baggage with the specific destination of the baggage.

It may, at least partly, be seen that the present invention lies in the insight that by handling baggage, and possibly particularly, early baggage, in accordance with the method and system described herein, lowered cost of handling baggage in an airport can be provided. This may be seen to be due to the possibility of improving coordination between the tasks to be carried out.

In particular it may be seen that by storing a plurality of loaded baggage totes in the baggage storage unit, near or at the end destination, less time is required for transport of the therein stored baggage pieces to the discharge at which they are required at. Thus, after opening a destination, in the sense that when the aircraft is or will soon be ready to take off, a number of baggage pieces is very soon, such as within less than 10 minutes, such as less than 5 minutes, such as less than 2 minutes, ready to be filled into an airport trolley or other device at that discharge or destination, for driving the airport trolley or the other device to the aircraft and loading the baggage into the aircraft.

Either this plurality of baggage pieces is all the baggage needed for the aircraft, or additional baggage can be required. Such additional baggage may be arriving sometime later, such as from a central baggage storage. But, in the meantime, the end destination may already have been emptied from the baggage which was stored in the decentralised baggage storage units, near or at the end destination. Thus, less discharges may also or additionally be needed with the method and system described herein.

This may be seen to improve the working conditions at the end destination in the leaving area, such as waiting times for the right discharges to be filled with baggage, while, e.g., alternatively or additionally enabling preventing high fluctuations in capacity requirements at various positions in the overall baggage handling system, such as in or in relation to the central baggage storage, or in relation to the conveyor lines leading to and from the central baggage storage etc.

Typically, early baggage has been seen as a particular problem, in that this type of baggage arrived particularly early and thus would take up storage space in the central storage for a particular long period. It is herein suggested, to some extent, to see such early baggage as a benefit, in that such baggage possibly enables for a longer period and thus to a larger extent than baggage entering later, to be transported to its end destination in the baggage handling system during a period with low capacity utilization.

The method and system described herein may be seen to enable carrying out a number of method steps in a special and unique way and enabling a certain positioning of the baggage storage units, and thus, e.g., preventing too high fluctuations in need of capacity when compared to reference methods and systems.

When the method includes that the method steps of separating (e), inserting (f) and withdrawing (h) are carried out by the same device, a method and corresponding device which may be seen to be particularly simple and easy to position in the leaving area is provided. When separating (e), inserting (f) and withdrawing (h) comprises movement of the loaded tote parallel or substantially parallel with a first direction this may be seen to be further improved.

A particular improvement may be seen to be provided when step d) includes storing the loaded baggage totes above each other and in-line with said conveyor line.

According to an embodiment of the invention step c) is carried out just after entering the piece of baggage in step a), such as maximum 5, 10, 15 or maximum 30 minutes after carrying out step a).

According to an embodiment of the invention the baggage storage unit is working so that the first loaded baggage tote inserted in step f) is the last loaded baggage tote which can be withdrawn in step h) from the baggage storage unit.

According to an embodiment of the invention the baggage handled is entered in step a), at least one hour before departure of the aircraft it is intended for, such as at least one and a half hour before departure, such as at least two hours before departure, such as longer than two and a half hour before departure, such as longer than three hours before departure.

In embodiments, the method may further comprise a step k) of controlling the airport baggage handling system in accordance with one or more inputs. Such inputs may include one or more of the following inputs k1) to k5):

k1) a height of the piece of baggage, when the piece of baggage is positioned in the automated airport baggage handling system,

k2) an input regarding whether or not to carry out step c), can be a determination of whether or not the end destination, such as at least which terminal the piece of baggage is intended for, is known upon check-in of the piece of baggage,

k3) an amount of storage space available in a central baggage storage,

k4) a distance or transport time for a piece of baggage, from a point of entrance in the system to the decentralised baggage storage and/or from the point of entrance to the end destination of the piece of baggage,

k5) a distance or transport time for a piece of baggage, from a centralised baggage storage and to the end destination of the piece of baggage.

According to an apparatus aspect of the invention there is provided an automated airport baggage handling system comprising
at least one induction for loading a piece of baggage onto a baggage tote of the airport baggage handling system,
at least one discharge for unloading baggage from the baggage tote,
one or more baggage storage units for storing baggage,
   where the one or more baggage storage units are each provided as a lift configured for storing a plurality of totes above each other, where each tote is loaded with a piece of baggage, and where the plurality of totes are stored in-line with a conveyor line used for transporting the baggage totes to and from the one or more baggage storage units.

The one or more of the possible advantages described for the method may be seen to be possible advantages for the apparatus aspect as well and vice versa. In particular, it may be seen as an advantage of the described system that when the baggage is stored in their totes above each other and in-line with the conveyor line used for transporting the baggage totes to and from the one or more baggage storage units, a particularly simple and yet effective way of storing baggage is provided.

With in-line is understood that left and right sides of the stored totes are flush or substantially flush with each other. Further and when the totes are also flush with the below conveyor line used for transporting the baggage totes to and from the one or more baggage storage units, this means that the same or substantially the same distance is provided from the left or right sides of the totes and to a left and right side of the conveyor line. In the embodiments described herein, also a front and rear end of baggage totes stored in a single baggage storage unit are aligned or substantially aligned with each other.

Hereby, it may be found that a unique method and a unique automated baggage handling system is provided, which has been found to decrease the cost of providing a certain transport time between certain locations, possibly and especially during certain peak performance periods of the material handling system.

In accordance with an embodiment of the invention, the one or more baggage storage units each comprises at least one set and preferably a plurality of sets of storing support members each set being provided for supporting a loaded tote above said conveyor line.

When at least one set of storing support members is moveable so as to provide an adjustable distance between individual sets of storing support members, a possible advantage is that one way of storing a maximized number of baggage pieces in a single baggage storage unit is provided. Alternatively or additionally, the baggage storage unit includes one or more sets of storing support members. When more sets, these sets are preferably distributed along the height of the elongated support structure, at known fixed positions.

In accordance with an embodiment of the invention the one or more baggage storage units each comprises at least one set of lifting support members which is moveable to and from the conveyor line and configured so as to engage and disengage the loaded tote and lift and lower the loaded baggage tote from and to said conveyor. It may be seen that hereby storage of a plurality of loaded totes above each other and separating, inserting, supporting and withdrawing can be provided in a simple and yet effective manner.

When the baggage storage unit is configured for being fitted onto an existing conveyor section and wherein said conveyor line is or comprises one or more existing conveyor sections, a possible advantage is that a unique way of preventing too high fluctuations in the need for capacity can be provided. Still further, it may be seen as an advantage that this can be provided within the existing footprint and with use of one or more of the existing conveyor sections. Two, three or more storage units may also be positioned above a single conveyor section.

According to a particular embodiment of the invention there is provided an automated baggage handling system according to any one of the apparatus claims and configured for carrying out the method according to any one of the method claims.

By referring to an advantage herein, it must be understood that this advantage may be seen as a possible advantage provided by the invention, but it may also be understood that the invention is particularly, but not exclusively, advantageous for obtaining the described advantage.

In general the various aspects and advantages of the invention may be combined and coupled in any way possible within the scope of the invention.

These and other aspects, features and/or advantages of the invention will be apparent from and elucidated with reference to the embodiments described hereinafter.

### BRIEF DESCRIPTION OF THE DRAWINGS

FIG. 1 is a simplified illustration of a typical baggage handling system in an airport.

Embodiments of the invention will be described, by way of example only, with reference to the drawings, in which

FIG. 2 is a simplified illustration of a baggage handling system in an airport,

FIG. 3 is a close up illustration of an area in an airport where baggage leave the baggage handling system,

FIG. 4 is a side view of a baggage storage unit,

FIG. 5 is a side view of the baggage storage unit, where a loaded tote is about to be engaged by lifting means for lifting the tote into the baggage storage unit,

FIG. 6 is a top view B-B of the baggage storage unit as illustrated in FIG. 5,

FIG. 7 is a side view of the baggage storage unit, where the loaded tote is engaged by the lifting means,

FIG. 8 illustrates lifting support members lifting the loaded tote,

FIG. 9 illustrates the loaded tote lifted to a top most position in the baggage storage unit,

FIG. 10 illustrates that a first set of storing support members has been engaged so as to support a first loaded tote when the lifting support members return to lift a second loaded baggage tote,

FIG. 11 illustrates lifting the second loaded baggage tote into the baggage storage unit,

FIG. 12 illustrates a second set of storing support members,

FIG. 13 is an end view illustrating the first and second set of storing support members as well as the lifting support members,

FIG. 14 illustrates engaging a lowermost loaded tote with the lifting support members, disengaging the second set of storing support members, and lowering the lowermost tote to the conveyor line,

FIGS. 15-17 show various configurations of decentralised baggage storages, each with a plurality of baggage storage units.

### DESCRIPTION OF EMBODIMENTS

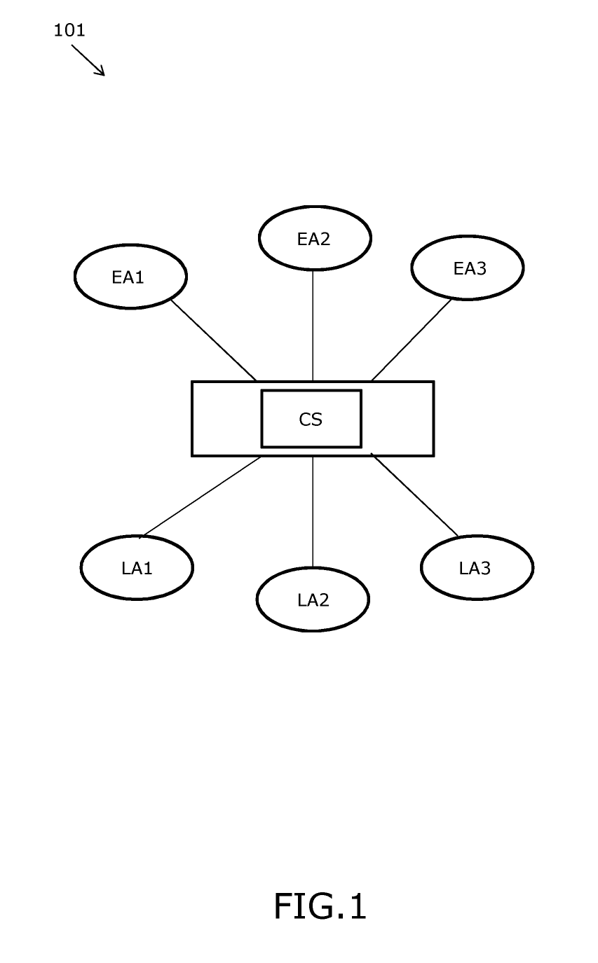

FIG. 1 is a simplified illustration of a part of a typical baggage handling system 101 in an airport. The illustration may be seen as a simplified illustration of one terminal in an airport. The system includes Entering Areas 1, 2 and 3, EA1, EA2 and EA3. Each entering area illustrates an area in the airport where baggage can and will enter the baggage handling system. The entering areas 1 and 2 may each, e.g., include a plurality of check-in stations, whereas entering area 3 includes one or more conveyor lines with transit baggage. The transit baggage may be baggage from another terminal of the airport.

The system also includes Leaving Areas 1, 2 and 3, LA1, LA2 and LA3. Each leaving area illustrates an area in the airport where baggage can and will leave the baggage handling system. The entering areas and the leaving areas are operably coupled with each other by the baggage handling system, and the baggage handling system also includes a Central baggage Storage, CS, positioned centrally relative to the Entering Areas 1-3 and the Leaving Areas 1-3.

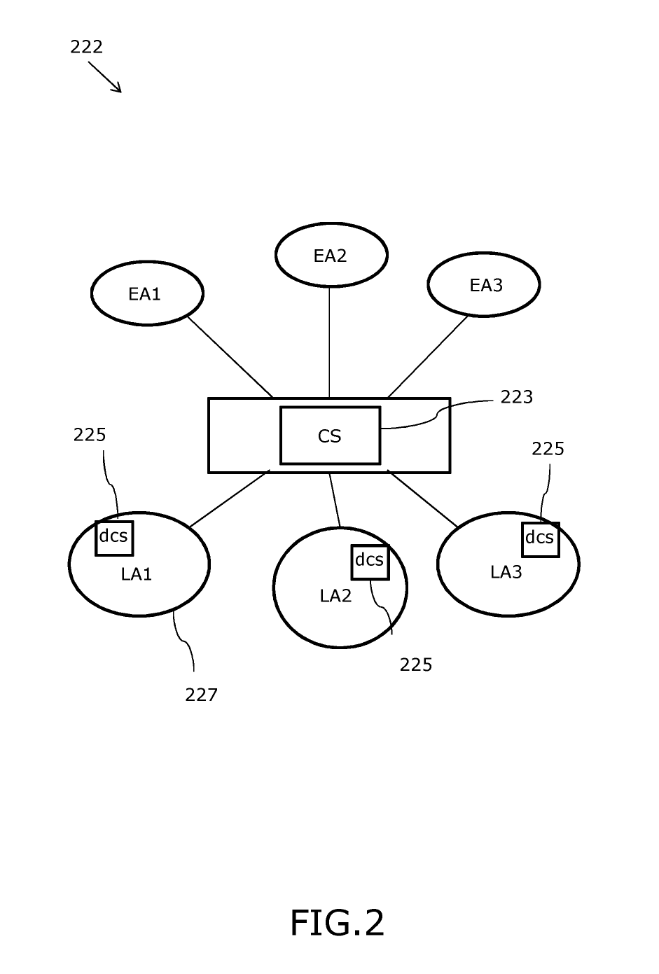

FIG. 2 is a simplified illustration of an automated baggage handling system 222 in an airport. The system includes entering areas EA1-3 and leaving areas LA1-3. The system also includes a central baggage storage, CS, 223. The entering areas and the leaving areas have the general functions as described for the typical system in FIG. 1. The central baggage storage 223 is provided for storing baggage which, for one or more reasons, has been found in need of being stored, e.g. during a period of time from the baggage has been checked in and until shortly before departure of an aircraft into which the baggage is finally to be loaded.

The figure also illustrates decentralised baggage storages, dcs, 225, positioned near or at an end destination of a particular piece of baggage in the automated baggage handling system. As illustrated each of a plurality, thus two or more, here three, leaving areas LA1-3, comprises decentralised baggage storage 225. The leaving area 1 (LA1), with the decentralised baggage storage 225, is illustrated as an encircled area in the baggage handling system with the reference number 227. This leaving area will be explained in further detail in the following.

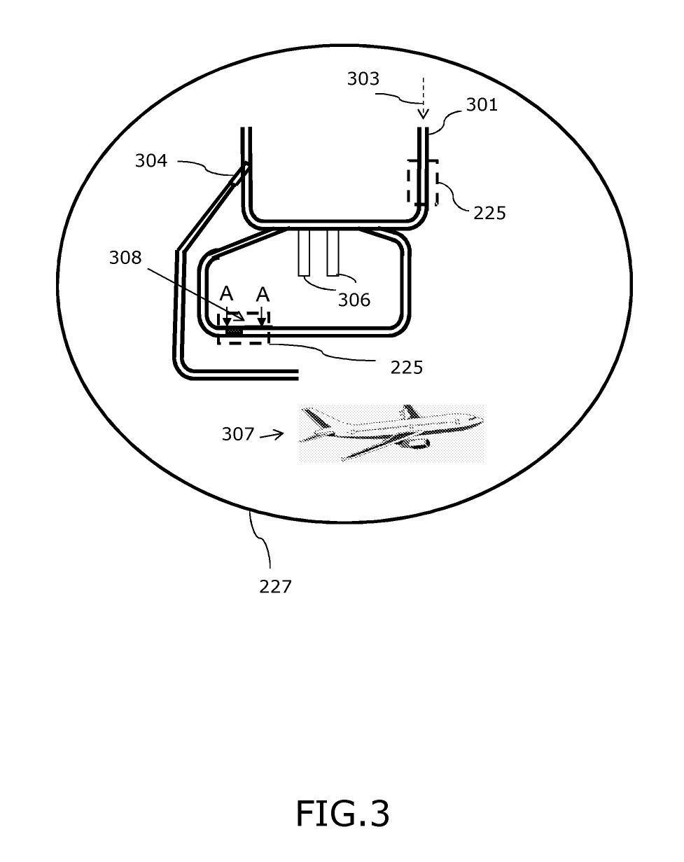

FIG. 3 is a close up illustration of the leaving area 227 where baggage leaves the baggage handling system. The figure illustrates a part of the automated baggage handling system where a number of conveyors 301 are provided for transporting baggage to and/or from the area. The conveyors are as examples belt and/or roller conveyors. The belt conveyors may be split belt conveyors. The direction in which the baggage is transported to the area is illustrated with the dashed arrow with the reference number 303. The illustrated system is configured for transporting baggage in baggage totes, where each tote typically is loaded with one piece of baggage at an induction. Such type of induction is illustrated at 304. The system also includes discharges 306 and a control system (not illustrated).

When a particular piece of baggage is required, the loaded baggage tote with that particular piece of baggage is moved to a discharge position at the discharge 306, where the tote can be emptied, and the baggage piece is finally moved from the illustrated part of the automated baggage handling system and into an aircraft 307.

The final movement of the baggage piece typically requires some form of manual operation, such as one or more of: supervision of or physically emptying one or more chutes with the baggage and filling the baggage into an airport trolley or other device (not shown), driving the airport trolley or the other device to the aircraft 307, loading the baggage into the aircraft 307. Such manual operation will be initiated in response to factors such as whether or not an aircraft is or will soon be present for departure and/or when personnel for the manual operation is available and/or what amount of baggage is positioned where in the system and/or when one or more amounts of baggage can be present at one or more positions in the system. In some systems and in some mode of operation of the systems baggage is handled according to the push principle and “pushed” from the central baggage storage when a fixed period of time remains before departure of an aircraft. In other modes of operation and/or in other systems, baggage is handled according to the pull principle and “pulled” from the central baggage storage when, e.g., an operator is ready for final manual operations in the leaving area.

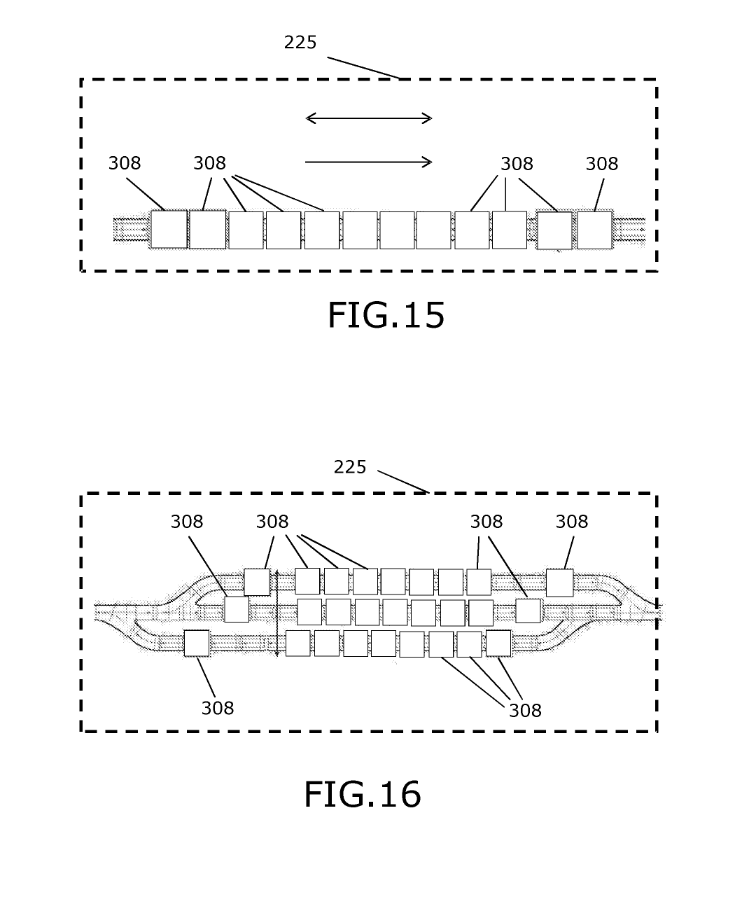

In this respect FIG. 3 illustrates that at one or more positions in the leaving area 227 a certain configuration 225 including one or more baggage storage units 308 is/are comprised in the automated baggage handling system. Such configurations at such illustrative positions are shown with the two dashed squares. One configuration is shown positioned at a conveyor line leading into the leaving area and one configuration at a conveyor near or close to the discharges 306. The conveyor close to the discharges is configured as a loop. Each configuration 225 may include one baggage storage unit, as will be described for the side view A-A, but each configuration may include any other number of baggage storage units 308 and possibly one or more conveyors leading to and/or from the one or more baggage storage units, as illustrated in FIGS. 15-17. The configurations with one or more baggage storage units 308 are as illustrated provided in, at, on or operably connected to parts of the automated airport baggage handling system.

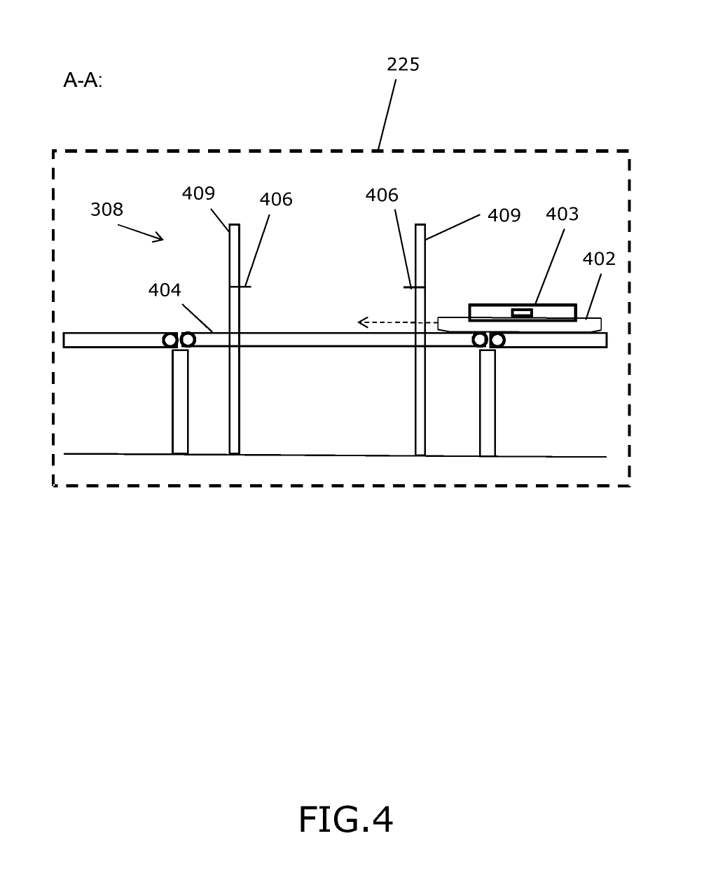

FIG. 4 is the side view A-A of the baggage storage unit 308 as indicated in FIG. 3. It is illustrated that the baggage storage unit 308 comprises a support structure, which is illustrated as a number of elongate support structures 409 positioned at a conveyor line 404 used for transporting the baggage totes to and from the baggage storage unit 308. A tote 402 loaded with a piece of baggage 403 is shown moving from right to left towards an area of the conveyor line where the support structure is provided. In the illustrated embodiment the elongate structures are supported on the floor, but they may additionally or alternatively be fixed to any other support structure, such as, e.g., fixed to stationary rigid parts of the conveyor 404.

The elongate support structures 409 include support means in the form of support members. At least one set of lifting support members 406 can be moved up or down along the elongate support structure 409 and operated so as to engage or disengage with one or more totes on the conveyor 404 or in the baggage storage unit 308. This will be further explained with reference to the following figures.

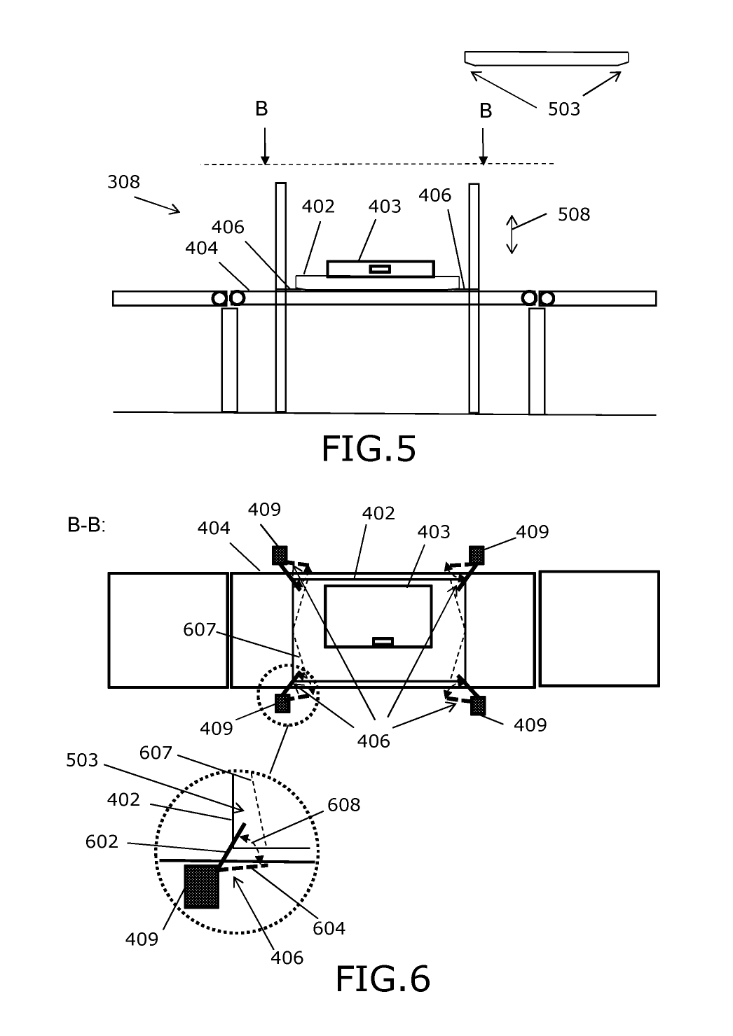

FIG. 5 is a side view of the baggage storage unit, where the loaded tote is about to be engaged by the one set of lifting support members 406 which is moveable to and from the conveyor line 404 in a first direction 508, parallel with or substantially parallel with gravity. The at least one set of lifting support members 406 is also configured so as to engage and disengage the loaded tote and lift and lower the loaded baggage tote from and to said conveyor 404. In the shown embodiment of the baggage storage unit, the at least one set of support members 406 is/are configured to engage the baggage tote at an engagement surface provided towards a corner of the tote 402.

It follows from the figure that the tote is provided with a slanted part 503. The slanted part 503 is provided towards a front end and a rear end of the tote and towards corners of the tote. The slanted part is provided at a bottom of the tote. It follows that the lifting support members are engaged with the tote at such slanted engagement surface of the tote. Using a surface of the slanted part as an engagement surface has proven particularly of benefit. In embodiments herein this solution has been chosen over other possible solutions, such as engagement with an alternative engagement surface, possibly at a void open space suitable for engagement with the tote. Such alternative engagement surface could, e.g., be a cavity or opening in the surface of the tote along the side and/or ends of the tote.

FIG. 6 is a top view B-B of the baggage storage unit as illustrated in FIG. 5. It follows that four elongate support structures 409 are provided, two elongated support structures on each side of the conveyor 404. It is illustrated that the lifting support members 406, of which the shown embodiment comprises a set of four, can be moved, in a second direction 608, between an engaged position 602, where the lifting support member 406 is engaged with the tote, and a disengaged position 604. In the shown embodiment the movement between engaged and disengaged positions of the lifting support members comprises pivoting or rotating the lifting support member. The illustrated rotation is about 40 degrees. Borders towards the slanted part of the tote are illustrated by the dashed lines 607.

Although four lifting support members are shown, the baggage storage unit could, e.g., work with only two lifting support members in the set of support members, e.g., one at each end of the tote, or two at one side of the tote, e.g. one towards or at each end of the tote. When using two at one side, such lifting support members would possibly have to be moved linearly from the side and under the tote, so as to be able to support the tote from the side, which may be unwanted and possibly less preferred than the illustrated solution. It follows that the movement of the lifting support members 406, between engagement and disengagement with the slanted part 503 of the tote, is a movement in the horizontal plane.

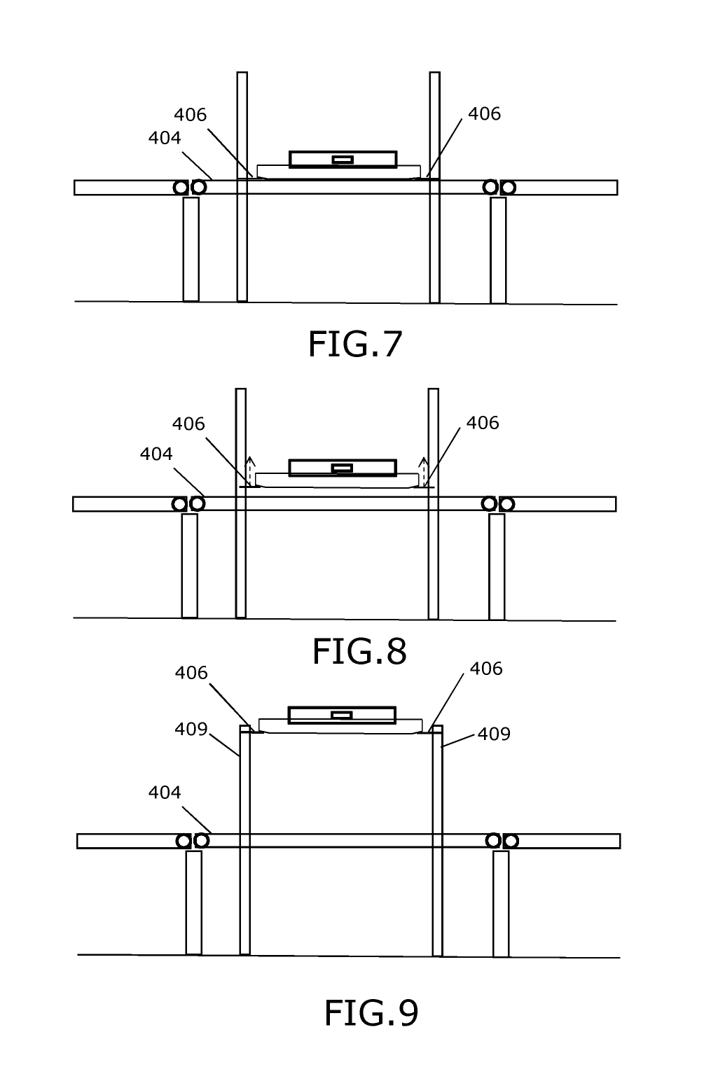

FIG. 7 is a side view of the baggage storage unit, where the loaded tote is engaged by the set of lifting support members 406, thus the lifting support members 406 are in their position 602.

FIG. 8 illustrates the lifting support members lifting the loaded tote and thus separating the loaded baggage tote from the conveyor line used for transporting the baggage totes to and from the baggage storage unit. Thus, inserting the loaded baggage tote into the baggage storage unit by lifting the loaded baggage tote from the conveyor line and into the baggage storage unit, and supporting the loaded baggage tote in the baggage storage unit, is illustrated.

FIG. 9 illustrates the loaded tote when lifted to a top most position in the baggage storage unit. In that none other loaded totes were already present in the baggage storage unit, the top most position is correlated to an end of the elongate support structures 409. Otherwise the position of the loaded tote in the baggage storage unit could be one of: a fixed next position in a baggage storage unit with fixed relative positions between loaded totes, and a position where a height of the baggage piece on the tote determines where the loaded tote is positioned in the baggage storage unit. The latter position is preferably optimised so as to position the loaded totes as close as possible to each other in the baggage storage unit.

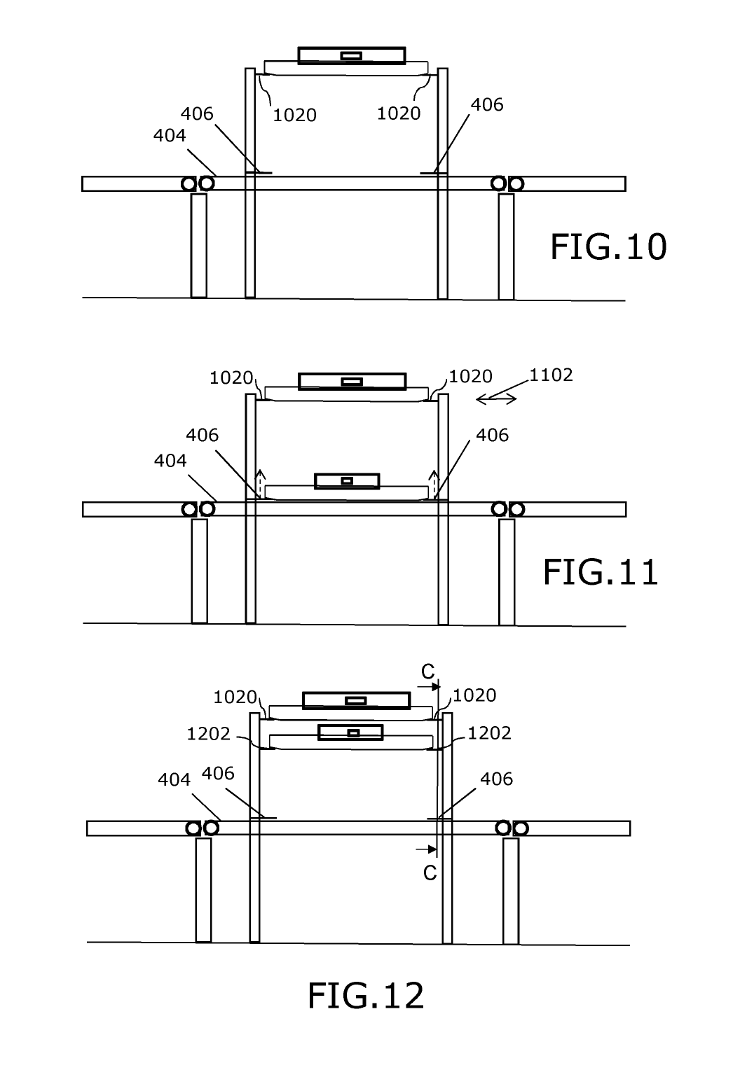

FIG. 10 illustrates that a first set of storing support members 1020 has been engaged so as to support the first loaded tote, e.g., just before the lifting support members 406 disengage the tote and return to lift and hereby insert another loaded baggage tote into the baggage storage unit. Possibly the first set of storing support members 1020 also engages the slanted part of the tote, but these members may be adapted to engage any other part of the tote. The storing support members are adapted such as, at least briefly, to be able to engage the stored tote while the lifting support members also engage the stored tote. In the shown embodiment the movement of the storing support members 1020 between engaged and disengaged positions thereof is substantially linear and substantially perpendicular to a front and a rear end of the tote and thus in the linear third direction 1102.

FIG. 11 illustrates lifting a second loaded baggage tote, which has previously been stopped on the conveyor line 404, into the baggage storage unit.

FIG. 12 illustrates a second set of storing support members 1202 which has been engaged so as to support the second loaded tote when the moveable lifting support members return to lift a possible third loaded baggage tote into the baggage storage unit. It can be seen that the loaded totes are stored above each other and in-line with the conveyor line 404.

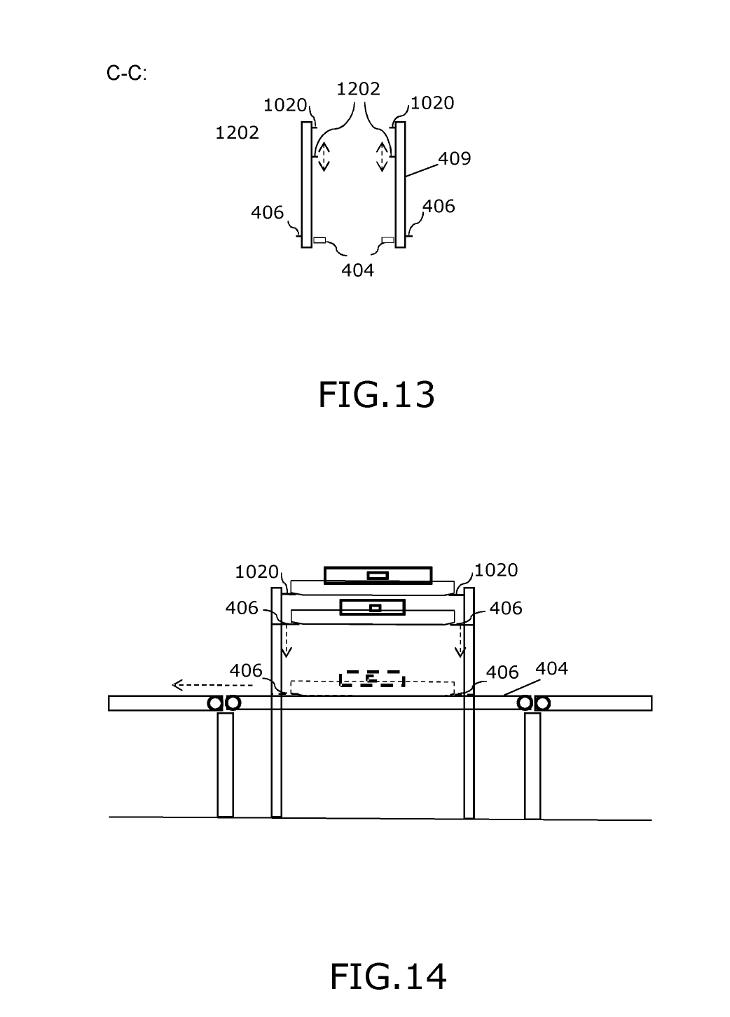

FIG. 13 is the end view C-C as indicated in FIG. 12 and illustrates the first and second set of storing support members 1020 and 1202, as well as the lifting support members 406. It is illustrated that the set of storing support members 1202 is individually moveable so as to provide an adjustable distance between the first and second individual sets of support members 1020 and 1202. Alternatively or additionally, one or more sets of storing support members may be positioned at known fixed position so as for the lifting support members 406 to stop at a position correlated to such known fixed position, whereby the storing support members then take over support of the loaded tote at such position. The number of storing support member sets can be such as one, two, three, four, five, six, seven, eight, nine, ten or possibly maximum 15 or 20 in dependence of how many loaded totes are to be stored in the baggage storage unit.

The distance between the individual sets of support members 1020 and 1202, and/or which sets of support members, to be used for particular loaded baggage totes, can be determined in response to a height of the piece of baggage on the loaded baggage tote, when the piece of baggage is positioned in the automated airport baggage handling system, determined by height determining means in the baggage handling system.

As shown in the figures the baggage storage unit and method enables that the loaded baggage totes are stored above each other and in-line with the conveyor line 404. The conveyor line comprises a conveyor belt in each of two sides of the conveyor for moving the tote by friction, the friction being provided between the tote and the conveyor.

FIG. 14 illustrates engaging a lowermost loaded tote with the moveable support members 406, disengaging the second set of storing support members 1202 and lowering the lowermost tote to the conveyor line 404 and hereby withdrawing the loaded baggage tote from the baggage storage unit for subsequent transport of the loaded baggage tote away from the baggage storage unit.

With the tote station and system described herein, one, two, three or more empty totes may be positioned on top of each other. Further, such one or more empty totes may be positioned below a tote loaded with a, preferably, small and/or light, piece of baggage. Such stack of one, two, three or more empty totes, possibly with the loaded tote placed on top of the one or more empty totes, may also be lifted at once from conveyor line 404, e.g. by support members 406 engaging a lowermost of the totes, and hereby be inserted and positioned at once in the storage unit 308.

Thus, the storage unit, system and method described herein may also be used to position empty totes on top of each other, i.e. to provide a stack of empty totes. This may be provided by lifting one or more empty totes into the storage unit and then positioning a further empty tote below the one or more empty totes on the conveyor line 404, and then also inserting the further empty tote in the storage unit. Inserting the further empty tote can be provided by lowering the totes in the storage unit onto the further empty tote and then lifting the further empty tote by a single set of lifting support members 406, or by using an unoccupied set of lifting support members and lifting the further empty tote with this set of lifting support members, while the totes in the storage unit remains in the storage unit being supported by another set of support members.

Still further, the storage unit, system and method described herein may also be used to release one, two, three, four or more single empty totes from the storage unit at once. The loaded tote on top of the one or more empty totes described herein would preferably have to be released from a tote station as a single tote prior to discharging its contents.

FIGS. 15-17 show various configurations 225 of decentralised baggage storages, each with a plurality of baggage storage units 308 and thus ways of how the baggage storage units 308 can be positioned, implemented and used in the automated baggage handling system. The plurality of baggage storage units are provided in-line and after each other along a conveyor line. In FIG. 15 twelve baggage storage units are positioned in-line and following each other on the same conveyor line. The conveyor line preferably comprises several conveyor sections, such as one conveyor section for each baggage storage unit. The arrows next to the conveyor line illustrate the direction in which the totes may or may not enter or leave one or more of the baggage storage units. This applies for all the configurations 225 including one or more baggage storage units described herein.

FIG. 16 illustrates a configuration 225 and a part of the automated handling system where a single conveyor line splits out into three parallel conveyor lines. This is illustrated with the two-way arrow crossing the three conveyor lines. Each of the three conveyor lines is equipped with nine baggage storage units 308.

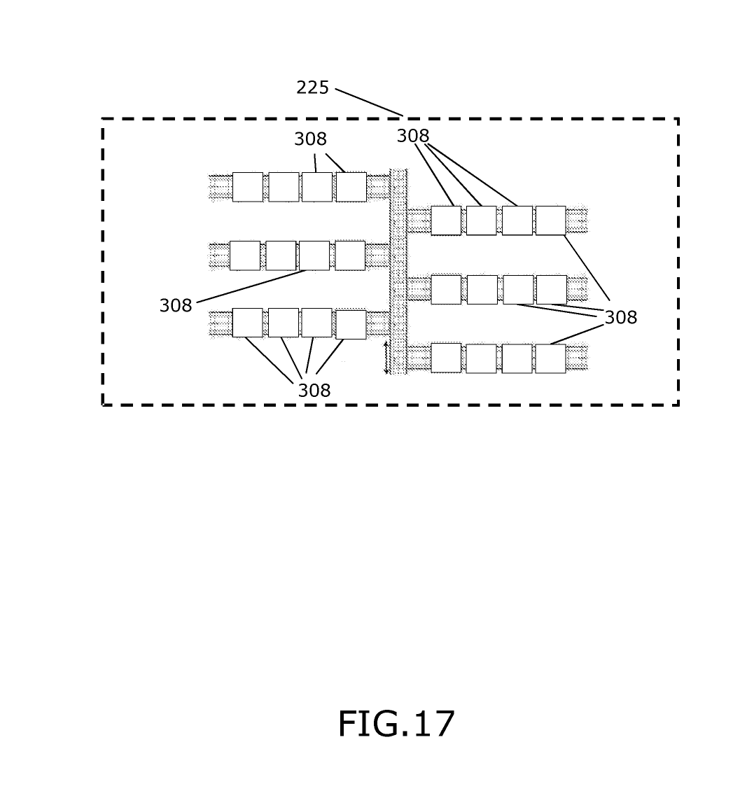

FIG. 17 illustrates a plurality of storage conveyor lines, six are shown, each storage line being provided with a plurality of baggage storage units 308. In the shown embodiment the storage lines have a dead-end and each of the four baggage storage units is provided for positioning a number of loaded totes above each other and for releasing loaded totes in the direction of the storage line. It can be noticed that in the shown embodiment in FIG. 17, the conveyors and baggage storage units are configured for totes travelling sideways in the storage lines, when compared to the connecting conveyor line. Each of the configurations 225 described herein may be seen as examples of how to use the baggage storage unit 308 as for storing totes above each other.

In short, it is herein disclosed that in order, e.g., to prevent high fluctuations in capacity requirements at various positions in a baggage handling system in an airport there is provided an automated airport baggage handling system 222 comprising an induction for loading a piece of baggage onto a baggage tote 402 of the airport baggage handling system, and a discharge 306 for unloading baggage from the baggage tote. The system further includes one or more baggage storage units 308, each being provided as a lift configured for storing a plurality of loaded baggage totes above each other, and where the plurality of totes are stored in-line with a conveyor line 404 used for transporting the baggage totes to and from the one or more baggage storage units 308.

Although the present invention has been described in connection with preferred embodiments, it is not intended to be limited to the specific form set forth herein. Rather, the scope of the present invention is limited only by the accompanying claims.

In this section, certain specific details of the disclosed embodiment are set forth for purposes of explanation rather than limitation, so as to provide a clear and thorough understanding of the present invention. However, it should be understood readily by those skilled in this art, that the present invention may be practised in other embodiments which do not conform exactly to the details set forth herein, without departing significantly from the spirit and scope of this disclosure. Further, in this context, and for the purposes of brevity and clarity, detailed descriptions of well-known apparatus, circuits and methodology have been omitted so as to avoid unnecessary detail and possible confusion.

In the claims, the term “comprising” does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Reference signs are included in the claims however the inclusion of the reference signs is only for clarity reasons and should not be construed as limiting the scope of the claims.

1. A method of handling baggage in an airport, in an automated airport baggage handling system, the method comprising:
a) entering a piece of baggage in the system,
b) loading the piece of baggage onto a baggage tote, to form a loaded baggage tote,
c) moving the loaded baggage tote towards an end destination of the piece of baggage in the automated airport baggage handling system,
d) storing a plurality of loaded baggage totes in a baggage storage unit, near or at the end destination, by
e) separating the loaded baggage tote from a conveyor line used for transporting the baggage totes to and from the baggage storage unit,
f) inserting the loaded baggage tote into the baggage storage unit by
f1) lifting the loaded baggage tote from the conveyor line and into the baggage storage unit, and
g) supporting the loaded baggage tote in the baggage storage unit, and when the baggage is needed:
h) withdrawing the loaded baggage tote from the baggage storage unit by lowering the loaded baggage tote from the baggage storage unit to the conveyor line,
i) emptying the tote at a discharge, and
j) moving the baggage from the automated airport baggage handling system and into an aircraft.

2-17. (canceled)

18. The method of handling early baggage in an airport according to claim 1, wherein the method steps of separating (e), inserting (f) and withdrawing (h) are carried out by the same device.

19. The method of handling baggage in an airport according to claim 1, wherein the method steps of separating (e), inserting (f) and withdrawing (h) comprise movement of the loaded tote parallel or substantially parallel with a first direction.

20. The method of handling early baggage in an airport according to claim 1, wherein step d) includes storing the loaded baggage totes above each other and in-line with said conveyor line.

21. The method of handling baggage in an airport according to claim 1, wherein the baggage storage unit is comprised in a decentralized baggage storage.

22. The method of handling baggage in an airport according to claim 1, wherein step c) is carried out just after entering the piece of baggage in step a).

23. The method of handling baggage in an airport according to claim 1, wherein the baggage storage unit is working so that the first loaded baggage tote inserted in step f) is the last loaded baggage tote, which can be withdrawn in step h) from the baggage storage unit.

24. The method of handling baggage in an airport according to claim 1, wherein the baggage handled is entered in step a) at least one hour before departure of the aircraft it is intended for.

25. The method of handling baggage in an airport according to claim 1, wherein the piece of baggage being handled is early baggage.

26. An automated airport baggage handling system, the automated airport baggage handling system comprising:
at least one induction for loading a piece of baggage onto a baggage tote of the airport baggage handling system,
at least one discharge for unloading baggage from the baggage tote,
one or more baggage storage units for storing baggage,
wherein the one or more baggage storage units are each provided as a lift configured for storing a plurality of totes above each other, where each tote is loaded with a piece of baggage, and wherein the plurality of totes are stored in-line with a conveyor line used for transporting the baggage totes to and from the one or more baggage storage units.

27. The automated airport baggage handling system according to claim 26, wherein the one or more baggage storage units each comprises at least one set or a plurality of sets of storing support members each set being provided for supporting a loaded tote above said conveyor line.

28. The automated airport baggage handling system according to claim 27, wherein at least one set of storing support members is moveable so as to provide an adjustable distance between individual sets of storing support members.

29. The automated airport baggage handling system according to claim 26, wherein the one or more baggage storage units each comprises at least one set of lifting support members, which is moveable to and from the said conveyor line and configured so as to engage and disengage the loaded tote and lift and lower the loaded baggage tote from and to said conveyor.

30. The automated baggage handling system according to claim 26, wherein the baggage storage unit is configured for being fitted onto an existing conveyor section and wherein said conveyor line is or comprises one or more existing conveyor sections.

31. The automated baggage handling system according to claim 30, wherein said conveyor line comprises a conveyor belt in each of two sides of the conveyor for moving the tote by friction, the friction being provided between the tote and the existing conveyor.

32. The automated baggage handling system according to claim 26, wherein a plurality of baggage storage units are provided in-line and after each other along said conveyor line.

33. A method of handling baggage in an airport, in an automated airport baggage handling system, said method comprising:
a) entering a piece of baggage in the system of claim 26,
b) loading the piece of baggage onto a baggage tote, to form a loaded baggage tote,
c) moving the loaded baggage tote towards an end destination of the piece of baggage in the automated airport baggage handling system,
d) storing a plurality of loaded baggage totes in a baggage storage unit, near or at the end destination, by
e) separating the loaded baggage tote from a conveyor line used for transporting the baggage totes to and from the baggage storage unit,
f) inserting the loaded baggage tote into the baggage storage unit by
f1) lifting the loaded baggage tote from the conveyor line and into the baggage storage unit, and
g) supporting the loaded baggage tote in the baggage storage unit, and when the baggage is needed:
h) withdrawing the loaded baggage tote from the baggage storage unit by lowering the loaded baggage tote from the baggage storage unit to the conveyor line,
i) emptying the tote at a discharge, and
j) moving the baggage from the automated airport baggage handling system and into an aircraft.
